(19) United States
(12) Patent Application Publication
(10) Pub. No.: US 2008/0285813 A1
(43) Pub. Date: Nov. 20, 2008

(54) APPARATUS AND RECOGNITION METHOD FOR CAPTURING EAR BIOMETRIC IN WIRELESS COMMUNICATION DEVICES

(75) Inventor: Paige M. Holm, Phoenix, AZ (US)

Correspondence Address: INGRASSIA FISHER & LORENZ, P.C. (MOT), 7010 E. Cochise Road, SCOTTSDALE, AZ, 85253, US

(73) Assignee: MOTOROLA, INC., Schaumburg, IL (US)

(21) Appl. No.: 11/747,985

(22) Filed: May 14, 2007

(51) Int. Cl. G06K 9/00

(52) U.S. Cl. 382/115

(57) ABSTRACT

An apparatus and method is provided for recognizing ear biometrics of an approved user of a wireless device. The apparatus comprises a wireless communication device (50) including a first biometric device (52) for assessing the identity of the user, the biometric device (52) comprising a touch input display (52) including a plurality of pixels for providing a visual output, and a plurality of sensors (84), one each being incorporated within one of the plurality of pixels (82), for recording at least a partial image of a user's ear (10) when the touch input display (52) is placed against an ear (10) of the user in a first mode and for receiving an input in response to being touched by the user in a second mode. A controller (120) is coupled to the first biometric device (52) in the first mode, wherein the controller (120) enables the function when the identity of the user is verified by the first biometric device (52). Additional biometric devices may be included wherein a positive response from one of the biometric devices enables the function of the wireless device.

### FIELD OF THE INVENTION

The present invention generally relates to verifying the identity of a person, and more particularly to a method for identifying and verifying an approved user of a wireless communication device.

### BACKGROUND OF THE INVENTION

Transactions of many types require a system for identifying a person (Who is it?) or for verifying a person's claimed identity (Is she who she says she is?). The term recognition refers to identification and verification collectively. Traditionally, three methods have been used for recognizing a person: passwords, tokens, and biometrics.

Biometrics refers to information measured from a person's body or behavior. Examples of biometrics include fingerprints, hand shapes, palm prints, footprints, retinal scans, iris scans, face images, ear shapes, voiceprints, gait measurements, keystroke patterns, and signature dynamics. The advantages of pure biometric recognition are that there are no passwords to forget or to give out, and no cards (tokens) to lose or lend.

In biometric verification, a user presents a biometric which is compared to a stored biometric corresponding to the identity claimed by the user. If the presented and stored biometrics are sufficiently similar, then the user's identity is verified. Otherwise, the user's identity is not verified.

In biometric identification, the user presents a biometric which is compared with a database of stored biometrics typically corresponding to multiple persons. The closest match or matches are reported. Biometric identification is used for convenience, e.g., so that users would not have to take time consuming actions or carry tokens to identify themselves, and also for involuntary identification, e.g., when criminal investigators identify suspects by matching fingerprints.

There is an ever-growing need for convenient, user-friendly security features on wireless communication devices. These devices have permeated our society and have become a primary mode of communication in voice, text, image, and video formats today, with the promise of even greater functionality in the future including high speed web access, streaming video, and even financial transactions. Authentication of the device user in these applications is of paramount importance and a significant challenge.

Biometric technologies are viewed as providing at least a partial solution to accomplish these objectives of user identity and different types of biometrics have been incorporated into wireless products for this purpose. The most common of these include fingerprint, face, and voice recognition. Most of these biometric technology implementations require some type of specialized hardware, e.g., swipe sensor or camera, and/or specific actions to be taken by the user to “capture” the biometric data, e.g., swiping a finger, pointing a camera, or speaking a phrase. The special hardware adds unwanted cost to the product in a cost sensitive industry, and the active capture can make the authentication process inconvenient to use.

Accordingly, it is desirable to provide a biometric technology that can be implemented with existing sensing components of the wireless device and in which the biometric data capture occurs passively, or unobtrusively, during the normal operation of the device, without intentional and time consuming action of the user. Furthermore, other desirable features and characteristics of the present invention will become apparent from the subsequent detailed description of the invention and the appended claims, taken in conjunction with the accompanying drawings and this background of the invention.

### BRIEF SUMMARY OF THE INVENTION

An apparatus and method is provided for recognizing ear biometrics of an approved user of a wireless device. The apparatus comprises a wireless communication device including a first biometric device for assessing the identity of the user, the biometric device comprising a touch input display including a plurality of pixels for providing a visual output, and a plurality of sensors, one each being incorporated within one of the plurality of pixels, for recording at least a partial image of a user's ear when the touch input display is placed against an ear of the user in a first mode and for receiving an input in response to being touched by the user in a second mode. A controller is coupled to the first biometric device in the first mode, wherein the controller enables the function when the identity of the user is verified by the first biometric device. Additional biometric devices may be included wherein a positive response from one of the biometric devices enables the function of the wireless device.

### BRIEF DESCRIPTION OF THE DRAWINGS

The present invention will hereinafter be described in conjunction with the following drawing figures, wherein like numerals denote like elements, and

FIG. 1 is a side view of a human ear illustrating characteristics;

FIG. 2 is a wireless communication device in accordance with an exemplary embodiment resting over a human ear;

FIG. 3 is a partial cross-section of a touch input display in accordance with the exemplary embodiment taken along line 4-4 of FIG. 3;

FIG. 4 is a block diagram of a wireless communications device in accordance with an exemplary embodiment; and

FIG. 5 is a flow chart illustrating the method of verifying a user of the wireless communication device in accordance with the exemplary embodiment.

### DETAILED DESCRIPTION OF THE INVENTION

The following detailed description of the invention is merely exemplary in nature and is not intended to limit the invention or the application and uses of the invention. Furthermore, there is no intention to be bound by any theory presented in the preceding background of the invention or the following detailed description of the invention.

The present invention comprises a method of capturing a distinctive, physical biometric, i.e., the shape of the ear, using a sensor incorporated within a touch input display in wireless communication devices and in the normal operation of the device, e.g., during a phone conversation.

Ear biometrics is a relatively unexplored biometric field, but has received a growing amount of attention over the past few years. There are three modes of ear biometrics: ear photographs, ear prints obtained by pressing the ear against a flat plane, and thermograph pictures of the ear. The most common implementation of ear biometrics is via photographs for automated identification applications. In practice, the main problem with this photographic implementation is the obscuration of the ear by headwear (hats), or hair, and inconsistent lighting conditions.

An ear print has sufficient distinctiveness to be considered a valid biometric for authentication purposes. FIG. 1 shows the characteristic ear features that are most distinctive for identification. Note that these features are more or less evenly distributed across the different regions of the ear 10. These features include the helix posterior 12, helix superior 14, helix anterior 16, pliegue superior 18, foseta 20, pliegue anterior 22, origin 24, trago 26, canal intertraguiano 28, zona 30, lobulo 32, antitrago 34, concha 36, fosa navicular 38, and pliegue inferior 40.

Ear characteristics meet most of the criteria for a good biometric. They are universal (substantially all humans), they are sufficiently distinctive to be of value for the purposes described herein in that they have a high level of permanency (they don't change much over time), and are readily collectable (as described herein).

There is a growing trend toward the use of touch input displays in high tier wireless communication devices, e.g., smart phones and PDAs. This is largely driven by the desire for efficient use of the limited surface area of the device. Typically, two user interface elements dominate the surface of the device: the keypad for input and the display for output. A touch input display input display (described in more detail hereinafter) combines the input and output user interface into a single element.

The touch input function can either be integrated into the display backplane or implemented in transparent layers applied over the surface of the display. There are at least three different touch input sensing technologies that have been demonstrated, including resistive, capacitive and optical. With the proper array-based implementation, each of these sensing modes is potentially capable of generating a “print” of an object that is placed in contact with the surface. Because there are no lenses used to project and create an image, this approach is called a “near field” mode of capture. Only the portion of the object that is in contact or close proximity with the input plane contributes to this print, so the print is a two-dimensional rendering only.

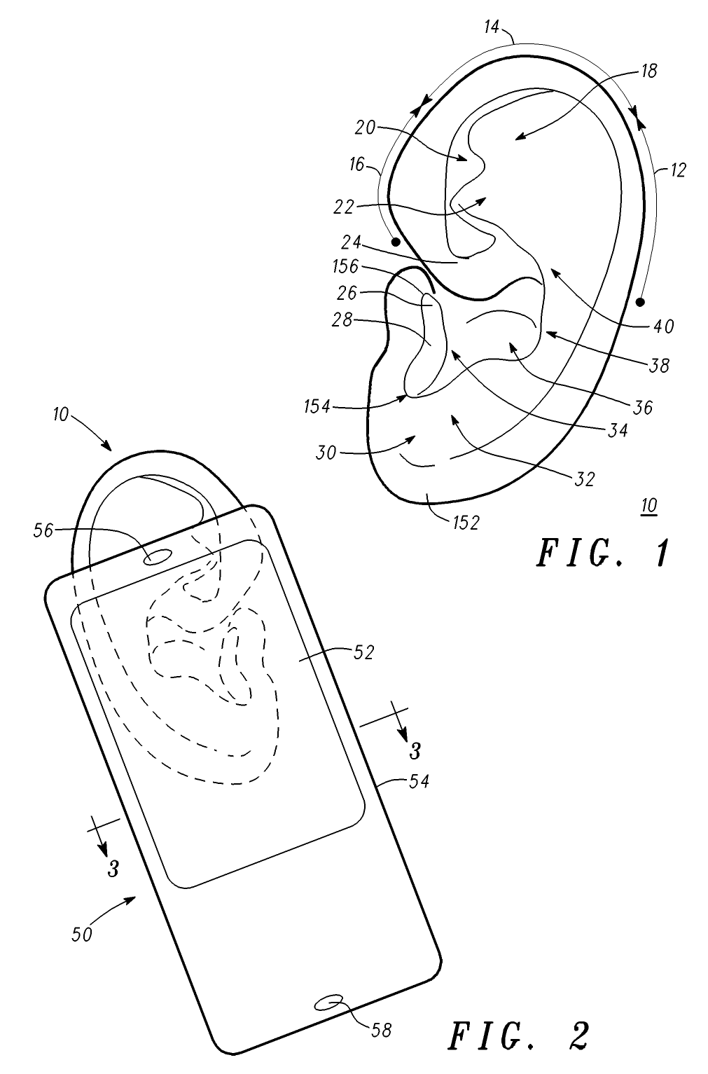

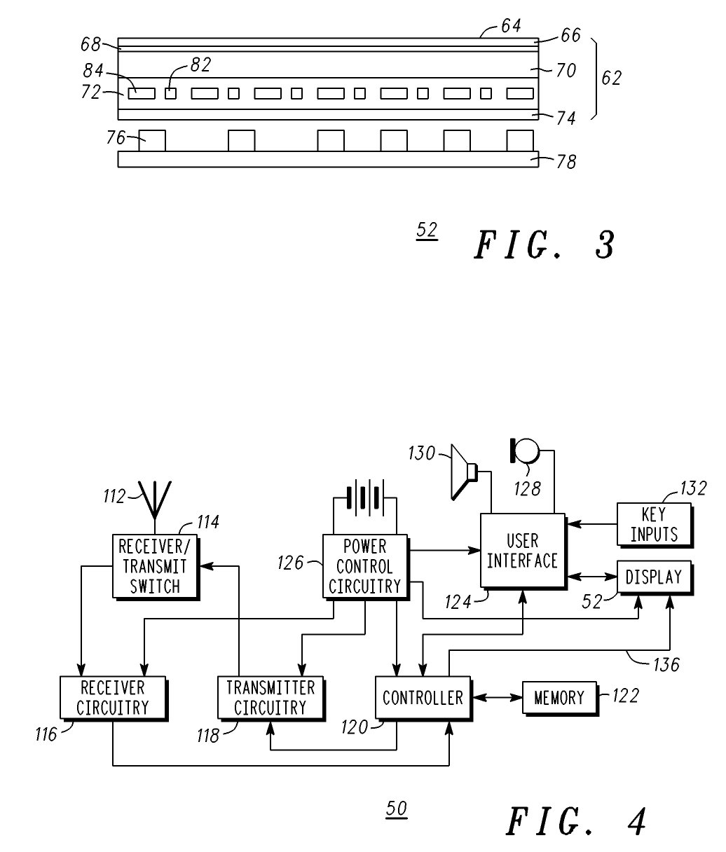

Referring to FIG. 2, a wireless communication device 50 (which may be incorporated within any portable electronic device, such as a PDA) is illustrated as a cell phone with a touch input display 52 (biometric device) positioned within a housing 54. The phone 50 will typically have a speaker 56 at one for delivering audio to the ear 10, a microphone 58 at the other to pick up voice input, and a large fraction of the phone's surface in between occupied by the touch input display 52. The touch input display 52 includes pixels and sensors (refer to discussion of FIG. 3 hereinafter) for providing a visual output and capturing a print of the ear 10, respectively. The phone 50 is flipped 180 degrees, facing away from the ear 10 for ease of understanding. Normally the phone 50 will have the touch input display 52, speaker 56, and microphone 58 facing the ear 10 during use. During normal use, the phone 50 would be placed against the ear 10 in such a manner that a significant portion of the ear 10, particularly the lower regions like the distinctive lobe 32 and concha 36 areas, would lie against the touch input display 52 allowing for capture of the ear print biometric. An optimal positioning of the speaker 56 with respect to the display area 52 could also generate a larger captured ear area. Three modes for capturing a print of the ear 10 by the touch input display 52, described hereinafter, comprise optical, resistive, and capacitive. For the optical mode of capture, backlighting of the display 52 can provide the illumination required. Resistive and capacitive modes of implementation would not require special illumination; however, a different scan or matrix mode of readout would be required.

Although the preferred exemplary embodiment of the phone 50 as shown illustrates a unitary body, any other configuration of wireless communication devices, e.g., a flip phone, may utilize the invention described herein. The phone 50 typically includes an antenna (not shown) for transmitting and receiving radio frequency (RF) signals for communicating with a complementary communication device such as a cellular base station or directly with another user communication device. The phone 50 may also comprise more than one display and may comprise additional input devices such as an on/off button and a function button.

Since phone conversations typically last an extended period of time, compared to the capture time, many input prints could be acquired for analysis to improve the accuracy of the biometric modality. And since most phone users position the phone underneath hair or caps covering the ear, and directly against the ear itself to achieve the best audio performance, this mode of acquisition is not hindered by such ear coverings.

The use of ears for biometric identification and verification provides several advantages over other biometric technologies, including: (1) ear biometrics are convenient and because their acquisition tends to be perceived as less invasive, (2) ear geometry readers work even if hands are dirty, unlike fingerprints, and (3) special sensors will not be required if the device employs an optical touchscreen. Ear biometrics generally comprise measuring physical dimensions and combinations thereof, such as the ratio between characteristic length or width; the pattern of lines on the ear; textures; colors; and other measurable characteristics of the ear. An ear biometric refers to a print of an ear, or parts of the ear; measurements that can be made from those images; representations that can be made from those images; or combinations of the images, the measurements, and the representations. An ear biometric as defined herein may comprise an image of an ear, and generally comprises measuring characteristics of the ear, e.g., lengths or distance between the characteristics.

Regardless of which of these embodiments, or another embodiment, is utilized, geometric measurements of the ear are made from the image, and compared with stored measurements of a person or persons. Values are assigned to the measurement comparisons. If the values are within a threshold, the identity of the person is verified.

Referring to FIG. 3, a cross section of the touch input display 52, comprising a low-temperature polycrystalline silicon TFT-LCD display, is depicted with the cross-section, for example, being a portion of a view taken along line 3-3 of FIG. 2. This technology is described in a publication: “Value-Added Circuit and Function Integration for SOG (System-on Glass) Based on LTPS Technology” by Tohru Nishibe and Hiroki Nakamura, SID 06 Digest. The display 52 includes a stack 62 with a user-viewable and user-accessible face 64 and multiple layers below the face 64, and typically includes a transparent cover 66, a thin transparent conductive coating 68, a substrate 70, an imaging device 72. The transparent cover 66 provides an upper layer viewable to and touchable by a user and may provide some glare reduction. The transparent cover 66 also provides scratch and abrasion protection to the layers 68, 70, 72 contained below.

The substrate 70 protects the imaging device 72 and typically comprises plastic, e.g., polycarbonate or polyethylene terephthalate, or glass, but may comprise any type of material generally used in the industry. The thin transparent conductive coating 68 is formed over the substrate 70 and typically comprises a metal or an alloy such as indium tin oxide or a conductive polymer.

An electroluminescent (EL) layer 76 is separated from the imaging device 72 by an ITO ground layer 74. The EL stack layer 76 includes a backplane and electrodes which provide backlight for operation of the display 52 in both ambient light and low light conditions by alternately applying a high voltage level, such as one hundred volts, to the backplane and electrode. The ITO ground layer 74 is coupled to ground and provides an ITO ground plane 74 for reducing the effect on the imaging device 72 of any electrical noise generated by the operation of the EL stack layer 76 or other lower layers within the display 52. Beneath the EL stack layer 76 is a base layer 78 which may include one or more layers. The various layers 66, 68, 70, 72, 74, 76, 78 are adhered together by adhesive layers (not shown) applied therebetween.

The imaging device 72 comprises a plurality of pixels 82 for displaying an image and a plurality of photosensors 84 for sensing touchscreen inputs on the transparent cover 66 of the display 52 in a first mode and for capturing a print of the ear in a second mode. Each pixel 82 may have one photosensor 84 associated therewith. When three pixels are grouped to form a triad of pixels to represent a color image, one photosensor 84 may be positioned with each triad, or with each pixel in the triad.

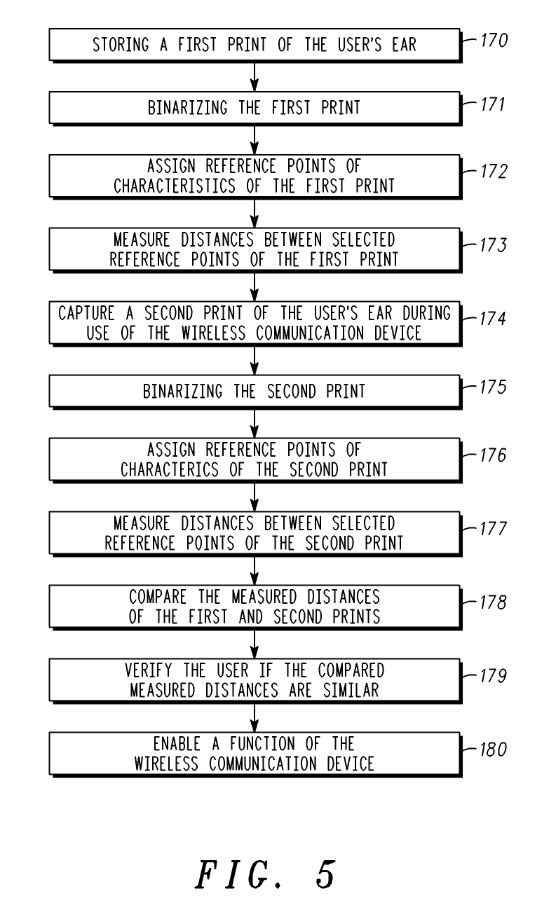

Referring to FIG. 4, a block diagram of a wireless communication device 50 such as a cellular phone, in accordance with the exemplary embodiment is depicted. The wireless electronic device 50 includes an antenna 112 for receiving and transmitting radio frequency (RF) signals. A receive/transmit switch 114 selectively couples the antenna 112 to receiver circuitry 116 and transmitter circuitry 118 in a manner familiar to those skilled in the art. The receiver circuitry 116 demodulates and decodes the RF signals to derive information therefrom and is coupled to a controller 120 for providing the decoded information thereto for utilization thereby in accordance with the function(s) of the wireless communication device 50. The controller 120 also provides information to the transmitter circuitry 118 for encoding and modulating information into RF signals for transmission from the antenna 112. As is well-known in the art, the controller 120 is typically coupled to a memory device 122 and a user interface 124 to perform the functions of the wireless electronic device 50. Power control circuitry 126 is coupled to the components of the wireless communication device 50, such as the controller 120, the receiver circuitry 116, the transmitter circuitry 118 and/or the user interface 124, to provide appropriate operational voltage and current to those components. The user interface 124 includes a microphone 128, a speaker 130 and one or more key inputs 132, including a keypad. The user interface 124 would also include the display 52 which includes touch screen inputs. The display 52 is coupled to the controller 120 by the conductor 136 for selective application of voltages.

Referring to FIG. 5, a method will be described for identifying and verifying a person in accordance with exemplary embodiments, in which a print is taken (images are stored) of an ear from the wireless device 50. As used herein, the words “capture”, “record”, “store” are meant to be used generically and interchangeably and mean that a print is electronically captured.

In accordance with the exemplary embodiment, a first print of an ear 10 as shown in FIG. 1 is taken and stored for later verification during normal use. The first print may be taken, for example, when the wireless communication device is first purchased. The first print is binarized 171 and image correction may be performed. Image correction may include, for example, filtering out noise. The binarized image is converted into chain codes in a manner known to those skilled in the art. Alternatively, a statistical model of the shape and appearance of the ear may be fitted to the first image and assignments made to reference points. Assignments are made 172, for example, for reference point 152 at the bottom edge of the lobulo 32, reference point 154 at the bottom of the canal intertraguiano 28, and reference point 156 at the top of the canal intertraguiano 28. It is appreciated many more points may be assigned. Distances between selected points are measured 173. For example, the distance from the point 152 to the point 154 is determined. Combinations of distances, such as ratios or logical comparisons, may also be determined. These values are stored for later comparison with prints taken during use of the wireless communication device.

During normal use, when a user holds the wireless communication device to his/her ear, a second print of the user's ear is taken 174. This second print is passively captured without any specific, intentional action taken by the user. The above steps are repeated for the second print by binarizing the second print 175, assign reference points 176, and measuring distances between reference points 177. These distances, combinations, or both are then compared 178 with stored distances, combinations, or both from previously stored images. The comparison may be carried out using any method of comparing quantities or sets of quantities, e.g., by summing squared differences. Values are assigned based on the comparison, and a determination is made whether the values are within a threshold. If the values are within a threshold, the identity of the person whose hand is being scanned is verified 179 and a function of the wireless communication device is enabled 180.

In another exemplary embodiment, the above described method of verifying the user based on a print taken of his/her ear may be only one of several biometric measurements taken for verification. An attempt to take two or more biometric samples, such as a voiceprint, a picture of the user's face, a fingerprint, as well as an ear print may be made. Since one particular biometric sample may not be obtainable, a successful capture of another biometric sample may enable a function on the wireless communication device.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention, it being understood that various changes may be made in the function and arrangement of elements described in an exemplary embodiment without departing from the scope of the invention as set forth in the appended claims.

1. A wireless communication device arranged and constructed to enable a function when an identity of a user is confirmed, the wireless communication device comprising:
a first biometric device for assessing the identity of the user, the biometric device comprising a touch input display including:
a plurality of pixels for providing a visual output; and
a plurality of sensors, one each being incorporated within each of the pixels, for recording at least a partial image of a user's ear when the touch input display is placed against an ear of the user in a first mode and for receiving an input in response to being touched by the user in a second mode; and
a controller coupled to the first biometric device in the first mode, wherein the controller enables the function when the identity of the user is verified by the first biometric device.

2. The wireless communication device of claim 1 wherein the plurality of pixels comprises a plurality of triads of pixels and the plurality of sensors comprises one each of a photosensor being associated with one of the triads.

3. The wireless communication device of claim 1 wherein the plurality of pixels comprises a plurality of triads of pixels and the plurality of sensors comprises one each of the sensors being associated with each of the pixels within each of the triads.

4. The wireless communication device of claim 1 further comprising a second biometric device for assessing the identity of the user, wherein the controller is coupled to the second biometric device, wherein the controller enables the function when the identity of the user is verified by one of the biometric device and the second biometric device.

5. The wireless communication device of claim 1 wherein the plurality of sensors comprise a plurality of photosensors and further comprising a backlight for lighting the ear in the first mode.

6. The wireless communication device of claim 1 wherein the plurality of sensors comprise one of optical, resistive, and capacitive sensors.

7. The wireless communication device of claim 1 wherein the controller includes software for measuring distances between characteristics of the user's ear and comparing the results with stored distances.

8. The wireless communication device of claim 1 wherein the controller determines physical characteristics of the user's ear and makes a comparison with stored physical characteristics of the user's ear.

9. A wireless communication device arranged and constructed to enable a function when an identity of a user is confirmed, the wireless communication device comprising:
a plurality of biometric devices, each of the plurality of biometric devices for assessing the identity of the user;
wherein one of the plurality of biometric devices comprises a touch input display including:
a plurality of sensors, one each being incorporated within one of the plurality of pixels, for recording at least a partial image of a user's ear when the touch input display is placed against an ear of the user in a first mode and for receiving an input in response to being touched by the user in a second mode; and
a controller coupled to the plurality of biometric devices for selecting one of the plurality of biometric devices when a corresponding predetermined condition is present,
wherein the controller enables the function when the identity of the user is confirmed by one of the plurality of biometric devices.

10. The wireless communication device of claim 9 wherein the plurality of pixels comprises a plurality of triads of pixels and the plurality of sensors comprises one each of a photosensor being associated with one of the triads.

11. The wireless communication device of claim 9 wherein the plurality of pixels comprises a plurality of triads of pixels and the plurality of sensors comprises one each of the sensors being associated with each of the pixels within each of the triads.

12. The wireless communication device of claim 9 wherein the plurality of sensors comprise a plurality of photosensors and the touch input display comprises a backlight for lighting the ear in the first mode.

13. The wireless communication device of claim 9 wherein the plurality of sensors comprise one of optical, resistive, and capacitive sensors.

14. The wireless communication device of claim 9 wherein the controller includes software for measuring distances between characteristics of the user's ear and comparing the results with stored distances.

15. The wireless communication device of claim 9 wherein the controller determines physical characteristics of the user's ear and makes a comparison with stored physical characteristics of the user's ear.

16. A method for enabling a feature on a wireless communication device comprising:
collecting a biometric sample of a user's ear from a biometric sensor comprising a touch input display including a plurality of photosensors; and
enabling the feature when the biometric sample corresponds to a known sample.

17. The method of claim 16 further comprising lighting the ear by a backlight formed as part of the touch input display.

18. The method of claim 16 further comprising measuring distances between characteristics of the ear for comparison with stored distances between characteristics of the ear.

19. The method of claim 16 wherein the collecting step occurs during a first mode, further comprising, during a second mode, displaying an image by pixels associated with each sensor and receiving an input by the sensors.

20. The method of claim 16 wherein the collecting step comprises:
storing a first print of the user's ear as a reference print;
binarizing the first print;
assigning reference points of characteristics of the first print;
measuring distances between selected reference points of the first print;
capturing a second print of the user's ear during use of the wireless communication device;
binarizing the second print;
assigning reference points of characteristics of the second print;
measuring distances between selected reference points of the second print;
comparing the measured distances of the first and second prints; and
verifying the user if the compared measured distances are similar.

21. The method of claim 16 wherein the collecting step comprises automatically collecting a print while the wireless communication device is placed against the user's ear during normal use.

22. A wireless communication device arranged and constructed to enable a function when the identity of a user is confirmed, the wireless communication device comprising:
a first biometric device comprising a touch input display including a plurality of sensors for capturing a biometric sample of a user's ear; and
a controller for enabling the function when the biometric sample corresponds to a known sample.
